(19) United States
(12) Patent Application Publication
(10) Pub. No.: US 2020/0361343 A1
(43) Pub. Date: Nov. 19, 2020

(54) Method and System for Controlling Seat Function in Vehicle

(71) Applicant: Alfmeier Präzision SE, Treuchtlingen (DE)

(72) Inventors: Katharina Röcker, Nürnberg (DE); Erich Dörfler, Landsberg (DE); Michael Scherb, Arberg (DE); Sascha Rohn, Treuchtlingen (DE)

(21) Appl. No.: 15/930,656

(22) Filed: May 13, 2020

(30) Foreign Application Priority Data
May 15, 2019 (DE) 10 2019 112 774.2

(51) Int. Cl. B60N 2/12; B60N 2/66; B60N 2/56; B60N 2/90

(52) U.S. Cl. CPC B60N 2/12; B60N 2/976; B60N 2/56; B60N 2/66

(57) ABSTRACT

A method for controlling at least one of a seat function and a comfort function with an operating unit, and with an onboard control device and a vehicle seat in a vehicle includes the following steps:
Establishing a connection between an operating unit or a server and the onboard control device;
Identifying the user;
Selecting at least one of a seat function and a comfort function; and
Selecting at least one given seat function option and/or comfort function option. A related system for controlling the seat function is also disclosed.

### CROSS-REFERENCE TO RELATED APPLICATIONS

This application claims benefit to German Patent Application Number 10 2019 112 774.2, filed May 15, 2019, which is incorporated in its entirety by reference herein.

### TECHNICAL FIELD

The disclosure relates to a method and system for controlling a seat function in a vehicle.

### BACKGROUND

It is known from the state of the art that seat functions such as seat adjustments, lateral supports, a lumbar support and/or a massage function, are controlled in a vehicle by control elements integrated into it. To control these seat functions, operating elements are generally installed in the seat, door, dashboard or steering wheel area. These seat functions can be operated by a user sitting in the car. For some of these functions (massage, for example) it may be necessary to switch on the ignition of the car. It is furthermore known that a profile must be saved for certain vehicle functions that the user can retrieve in the car by operating the corresponding operating element, so that the seat can be, for example, automatically adjusted to a given seat position consisting of seat height, lateral position and backrest inclination.

It is also known from the state of the art, for example, that an auxiliary heater can be operated via an infrared signal with a remote control assigned to the vehicle. The known systems are especially suitable for vehicles assigned to one or a few users. In vehicles available to many users via car sharing, for example, or in a company car fleet, users must individually adjust the seat functions and/or comfort functions each time or at least in each vehicle. Moreover, it can be desirable in the car sharing area if such an additional function can be individually billed so it becomes necessary to charge for the use of such additional functions.

### SUMMARY

An objective of the disclosure is to eliminate the disadvantages according to the state of the art.

The objective with regard to the method and the system are solved with the features disclosed below. Useful embodiments result from the optional features disclosed below.

The method according to the disclosure to control a seat function and/or comfort function with an operating unit in a control device onboard the vehicle and a vehicle seat in a vehicle includes the following steps:
Establishing a connection between an operating unit or a server and the control device;
Identifying the user;
   Selecting a seat function and/or comfort function; and
   Selecting one or several given seat function and/or comfort function options.

In the embodiment, the method includes the selection of only one seat function or only one comfort function.

The established connection can be suitable for unidirectional or bidirectional data exchange.

The onboard control device can be a vehicle control device, a control device assigned to the seat or one provided only for executing the method in the vehicle, a control device that can be retrofitted, for example.

Here, the operating unit can be a network-compatible, especially an internet-compatible terminal device, particularly selected from a computer, smartphone, tablet or navigation device. At the same time, the selection of the seat function and/or comfort function and the selection of one or several given seat function and/or comfort function options can take place shortly before or during driving. Alternately, the option(s) can already be chosen beforehand and the corresponding selections saved in a respective user profile in the operating unit or in a server or internet-compatible data storage such as a cloud, for example. The method must include the identification of the user. To identify the user, a corresponding identification information or identification key is transmitted to the onboard control device. It can be transferred, for example, from a smartphone as operating unit to the onboard control device. In order to generate such identification information, it may be necessary, for example, to photograph a QR code found in the vehicle and generate the identification key by means of a corresponding software. Alternately, the onboard control device can be connected to a reading device. In this case, it can be, for example, an NFC reader or the like capable of reading a user-assigned RFID chip, a credit card, an identification document or the like, for example. Alternately or additionally, an additional operating unit in form of an internet-compatible multifunctional device that can be a navigation device, can be installed in the vehicle. The additional operating unit can allow the entry of an identification key. Thus, the method can be implemented with the operating unit inside or outside the vehicle.

In the embodiment, the establishment of a connection consists of establishing a connection between the control device and the operating unit and establishing a connection between the operating unit and a server or establishing a connection between the control device and the server, wherein an identification key is exchanged between the operating unit and the control device and/or the server. The connection can be a direct or indirect one, particularly a tunnel connection.

In another embodiment, the seat function is selected from a lateral seat position, a vertical seat position, a seat surface inclination, a backrest inclination, a lateral support function, a lumbar support function, a seat heater, and a massage function. The selection of the comfort function can comprise an auxiliary heater or air conditioning, windshield heater or sensor cleaning.

The connection between operating unit and control unit comprises expediently an internet connection and a direct wireless connection, especially to a known optical connection, such as an infrared or radio connection. For this, known close-range transmission processes are especially considered. Alternately or additionally, a mobile telecommunication connection is also considered.

Furthermore, the onboard control device can transmit the selected seat function and/or comfort function options to one or several additional control devices for controlling the respective seat function and/or comfort function. Expediently, the selection of a seat function and/or comfort function and/or the selection of one or several given seat function and/or comfort function options in a user profile is saved in the operating unit or in the server. Thus, the user profile can include, for example, the seat height adjustment and inclination as well as the backrest inclination. Furthermore, the user profile can include turning on the seat heating for 5 minutes and a 10-minute massage profile for the driver if he wishes it after driving for one hour. Such a massage profile can be a medicinal massage profile to stimulate circulation, for example. Optionally, the user profile can also include an external temperature comparison with a sensor value, for example, so that a seat heating or auxiliary heating or the respective cooling switches on a corresponding function only below or above a temperature threshold value.

In the embodiment, the selection of one or several given seat function and/or comfort function options is forwarded to an accounting system. For example, using a driver's seat massage option for 5 minutes and using the seat heating of the passenger seat for 10 minutes can be read and transmitted to the accounting system. The transmitted data can include start, duration, intensity or power usage and end of the seat heating option, for example. Since the accounting system is expediently connected to the server, a car sharing provider can therefore, for example, offer seat or comfort functions that can be added.

In the embodiment, the seat function and/or comfort function is/are reset when leaving the vehicle. On the one hand, this has the advantage of minimizing a possible power usage or fuel consumption. In addition, the vehicle is thus in a defined state when the next user wants to use the vehicle.

The system according to the disclosure for controlling a seat function and/or comfort function in a vehicle comprises an operating unit and an onboard control device as well as a vehicle seat in a vehicle,
wherein the operating unit has one or several data interfaces;
wherein the onboard control device has at least one receiver and the onboard control device is connected to the vehicle; and
wherein the vehicle seat is equipped with one or several seat functions and/or the vehicle with one or several comfort functions, which in each case can take a given position or a given function through a control command of the control device.

The onboard control device can be a vehicle control device, a control device assigned to the seat or one only provided for executing the method in the vehicle, such as a control device that can be retrofitted.

Expediently, the operating unit is a network-compatible terminal device; in particular, the operating unit is selected from a computer, smartphone, tablet or navigation device. In the embodiment, the operating unit is or can be connected to the internet, is or can be connected to a mobile communication network and/or is equipped with one or several receivers and senders or transceivers.

The establishment of a connection comprises expediently the establishment of a connection between the control device and the operating unit, and the establishment of a connection between the operating unit and a server, or the establishment of a connection between the control device and the server, wherein an identification key is exchanged between the operating unit and the control device and/or the server. The connection to the server is expediently a network connection or internet connection.

In the embodiment, the seat function is selected from: a lateral seat position, a vertical seat position, a seat surface inclination, a backrest inclination, a lateral support function, a lumbar support function, a seat heating, and a massage function. Additionally or alternately, one or several of the following comfort functions can be optionally selected: one auxiliary heating or air conditioning, windshield heating or sensor cleaning. Every one of the functions can be controlled via an electrical or electronic control signal.

In the embodiment, the operating unit comprises an interface for an internet connection or mobile telecommunications connection and at least one sender for an optical connection or radio connection, and the control unit an interface for an internet connection or mobile telecommunications connection and at least one receiver for the optical connection or radio connection, wherein the radio connection is especially a direct radio connection.

The system can furthermore comprise one or several additional control devices suitable to control at least one seat function and/or comfort function and to communicate with the control device. The control device and the one or additional control devices can be collectively designed for wired or wireless communication. In wired communication, the wiring harness of the vehicle can be optionally used. The control device and the one or additional control devices can be optionally suitable for communicating an actual state of the respective seat function or comfort function back to the operating unit.

In the embodiment, the system can include data storage for storing a user profile, wherein the data storage is arranged in the operating unit or in the server or in a cloud.

Expediently, the system furthermore includes an accounting system expediently connected to the server or arranged in the server.

The computer program product is suitable for executing a method according to the disclosure. In particular, it is a computer program is an application, also known as a so-called “app.”

The computer program product according to the disclosure is optionally stored in a data carrier according to the disclosure.

### BRIEF DESCRIPTION OF THE DRAWINGS

The disclosure will be explained in more detail below, also with regard to additional features and advantages, and with reference to the enclosed drawings, which show in each case in a schematic diagram:

FIG. 1 is a diagrammatic view of a system to control a seat function;

FIG. 2 is a diagrammatic view of connections between the individual system components;

FIG. 3 is a flowchart showing a first embodiment of a method according to the disclosure;

FIG. 4 a flowchart showing a second embodiment of a method according to the disclosure;

FIG. 5 is a flowchart showing a third embodiment of a method according to the disclosure; and

FIG. 6 is a flowchart showing a fourth embodiment of a method according to the disclosure.

### DETAILED DESCRIPTION

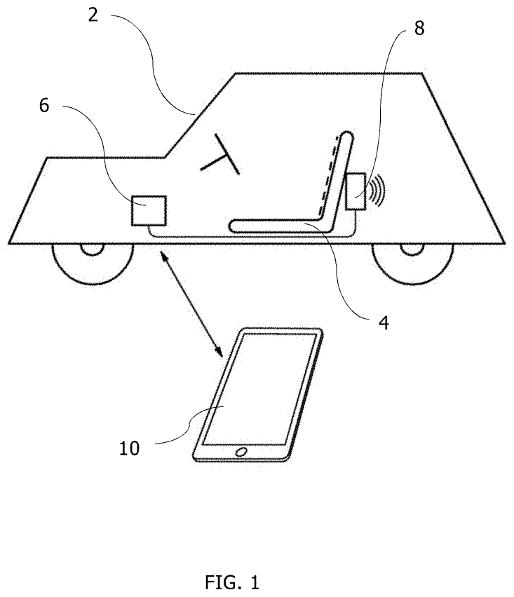

FIG. 1 shows a system for controlling a seat function in a vehicle 2. The system comprises an operating unit 10 and an onboard control device 6 as well as a vehicle seat 4 in the vehicle 2. In the embodiment shown, the operating unit 10 is a smartphone or tablet in which an app of a car sharing provider is installed. Such a smartphone or tablet has at least the possibility to connect to the internet. The app offers the possibility of storing a user profile. Such data can be locally stored in the operating unit 10 or in a server 12.

The onboard control device 6 has at least one receiver, preferably also one sender, and the control device 6 is connected to the vehicle 2. The vehicle seat 4 is equipped with one or several seat functions, for example an electronic seat adjustment, a seat heating or a lumbar support function and a massage system. Furthermore, the vehicle can be equipped with one or several comfort functions, such as a seat heating with optional cooling function. An additional control device 8 that controls the air supply to the provided massage bubbles for the vehicle seat 4 through valves is provided here for operating a massage system, for example. The massage system is expediently equipped with a programmable massage program sequence. In principle, it is also possible for the control device 8 to also include the functions of the control device 6.

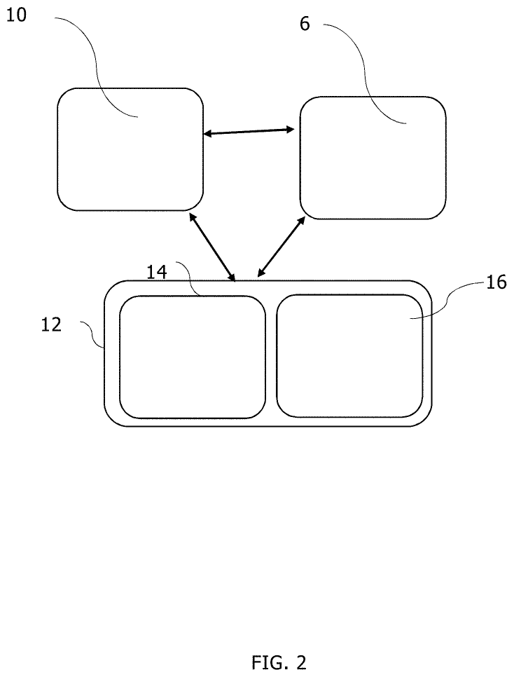

FIG. 2 shows a schematic diagram of the system. With the onboard control device 6, the operating unit 10 can be directly connected to the data transfer. Furthermore, the system includes a connection to a server 12 originating from the operating unit 10 and the onboard control device 6. The connection to the server 12 is especially a network connection or internet-based connection. However, it is possible to replace one of the three connections shown between operating unit 10, onboard control device 6, and server 12 with a connection, especially a tunnel connection, by means of one of the components, so that for example a direct communication between the onboard control device 6 and server 12 is replaced by a tunnel connection by means of the operating unit 10. In the embodiment shown, the server 12 includes a data storage 14 and an accounting system 16. Furthermore, the server 12 expediently includes a database system.

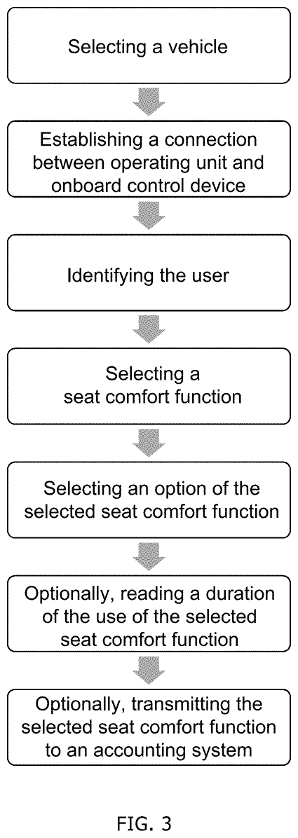

FIG. 3 shows an initial procedure of the method according to the disclosure. The method includes the steps:
Selecting a vehicle 2;
Establishing a connection between operating unit 10 and onboard control device 6;
Identifying the user;
Selecting a seat comfort function;
Selecting an option of the selected seat comfort function;
Optionally, reading the duration of use of the selected seat comfort function; and
Optionally, transmitting the selected seat comfort function to an accounting system 16.

In this method procedure, the user can use his smartphone to select, for example, that he would like to book a massage. Furthermore, he can select a massage procedure. Optionally, it can then be verified whether the use of this function is included or an extra charge must be paid.

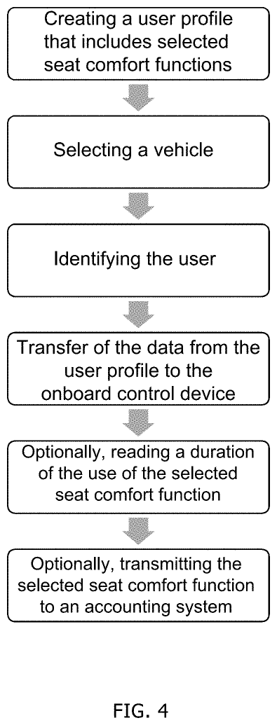

FIG. 4 shows another embodiment of a method with the steps:
Creating a user profile that includes selected seat comfort functions;
Selecting a vehicle;
Identifying the user;
Transferring the data from the user profile to the onboard control device;
Optionally, reading the duration of use of the selected seat comfort function; and
Optionally, transmitting the seat comfort function to an accounting system.

Here, a user profile can be comfortably created, for example, in the home computer serving as operating unit. This user profile can then be transferred to the selected vehicle after the user has been identified. In this variant of the method, the user has the advantage that complicated default settings are dropped, thereby allowing a customized driving experience in spite of changed vehicles.

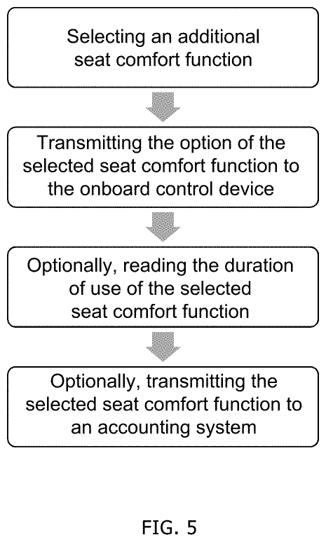

FIG. 5 shows a possible expansion of the method from FIG. 3 or 4 by the steps:
Selecting another seat comfort function;
Transmitting the selected seat comfort function option to the onboard control device;
Optionally, reading the duration of use of the selected seat comfort function; and
Optionally, transmitting the selected seat comfort function to an accounting system 16.

The user can thus supplement a selection made in the vehicle and also an already existing user profile, for example, by medium-level lumbar support in the lowest backrest area. The additional selection can be optionally added to the user profile.

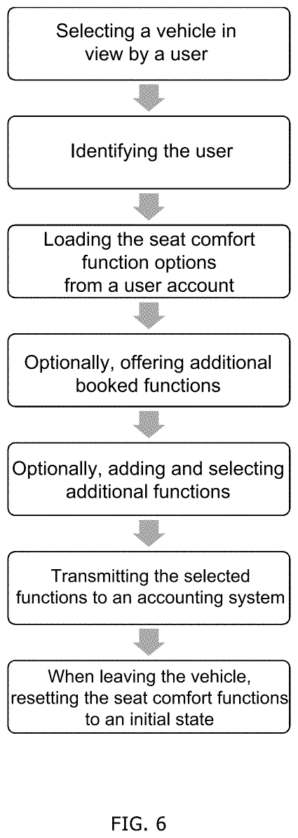

FIG. 6 shows another embodiment of the method according to the disclosure that includes the steps:
Selecting a vehicle in view by a user;
Identifying the user;
Loading the seat comfort function options from a user profile;
Optionally, offering additional booked functions;
Optionally, adding and selecting further functions;
Transferring the selected functions to an accounting system; and
When leaving the vehicle, resetting the seat comfort functions to an initial state.

The user can thus comfortably get into an equipped vehicle customized for him.

### LIST OF REFERENCE NUMERALS

2 Vehicle

4 Vehicle seat

6 Control device

8 Additional control device

10 Operating unit

12 Server

14 Data storage

16 Accounting system

1. A method for controlling one of a seat function and a comfort function with an operating unit, and with an onboard control device and a vehicle seat in a vehicle, the method comprising the following steps:
Establishing a connection between the onboard control device and one of an operating unit and a server;
Identifying the user;
Selecting at least one of a seat function and a comfort function; and
Selecting at least one given seat function option and/or comfort function option.

2. The method according to claim 1, wherein the operating unit is a network-compatible terminal device, especially selected from a computer, smartphone, tablet or navigation device.

3. The method according to claim 1, wherein the establishment of a connection includes the establishment of a connection between the control device and the operating unit and the establishment of a connection between the operating unit and a server or the establishment of a connection between the control device and the server, wherein an identification key is exchanged between the operating unit and the control device and/or the server.

4. The method according to claim 1, wherein the seat function is selected from: a lateral seat position, a vertical seat position, a seat surface inclination, a backrest inclination, a lateral support function, a lumbar support function, a seat heating, and a massage function.

5. The method according to claim 1, wherein the connection between operating unit and control unit includes an internet connection and a direct wireless connection.

6. The method according to claim 1, wherein the control device transmits the selected seat function and/or comfort function options to one or several additional control devices for controlling the respective seat function and/or comfort function.

7. The method according to claim 1, wherein the selection of a seat function and/or comfort function and/or the selection of one or several given seat function options is stored in a user profile in the operating unit or in the server.

8. The method according to claim 1, wherein the selection of one or several given seat function and/or comfort function options is forwarded to an accounting system.

9. The method according to claim 1, wherein the seat functions and/or comfort function are reset to an initial state upon leaving the vehicle.

10. A system for controlling a seat function and/or comfort function in a vehicle, the system comprising:
an operating unit; and
a control device and a vehicle seat in a vehicle;
wherein the operating unit has one or several data interfaces;
wherein the control device has at least one receiver and the control device is connected to the vehicle; and
wherein the vehicle seat is equipped with one or several seat functions and/or the vehicle is equipped with one or several comfort functions, which in each case can take a given position or a given function by means of a control command of the control device.

11. The system according to claim 10, wherein the operating unit is a network-compatible terminal device, especially selected from a computer, smartphone, tablet or navigation device.

12. The system according to claim 10, wherein the establishment of a connection comprises the establishment of a connection between the control device and the operating unit and the establishment of a connection between the operating unit and a server or the establishment of a connection between the control device and the server, and wherein an identification key is exchanged between the operating unit and the control device and/or the server.

13. The system according to claim 10, wherein the seat function is selected from: a lateral seat position, a vertical seat position, a seat surface inclination, a backrest inclination, a lateral support function, a lumbar support function, a seat heating, and a massage function.

14. The system according to claim 10, wherein the operating unit includes an interface for an internet connection and at least one sender for an optical connection or radio connection and wherein the control unit includes an interface for an internet connection and at least one receiver for the optical connection or radio connection.

15. The system according to claim 10, further including at least one additional control devices, which are suitable for controlling at least one seat function and communicating with the control device.

16. The system according to claim 10, further including a data storage for storing a user profile, wherein the data storage is arranged in the operating unit or in the server or a cloud.

17. The system according to claim 10, further including an accounting system.

18. A computer program product for executing a method according to claim 1.

19. A data carrier including the computer program product according to claim 18.
